(19) United States
(12) Patent Application Publication
(10) Pub. No.: US 2014/0175957 A1
(43) Pub. Date: Jun. 26, 2014

(54) ROTOR ASSEMBLY AND BRUSHLESS DC MOTOR COMPRISING THE SAME

(71) Applicant: Zhongshan Broad-Ocean Motor Co., Ltd., Zhongshan (CN)

(72) Inventors: Songfa TANG, Zhongshan (CN); Jianhua ZENG, Zhongshan (CN); Xianjun LIU, Zhongshan (CN); Mingpan PAN, Zhongshan (CN); Chongsheng ZENG, Zhongshan (CN)

(73) Assignee: Zhongshan Broad-Ocean Motor Co., Ltd., Zhongshan (CN)

(21) Appl. No.: 14/192,779

(22) Filed: Feb. 27, 2014

Related U.S. Application Data
(63) Continuation-in-part of application No. PCT/CN2012/082635, filed on Oct. 9, 2012.
Application No. PCT/CN2012/082635 is a continuation-in-part of application No. PCT/CN2012/082626, filed on Oct. 9, 2012.
Application No. PCT/CN2012/082626 is a continuation-in-part of application No. PCT/CN2012/082648, filed on Oct. 9, 2012.

(30) Foreign Application Priority Data
May 30, 2012 (CN) 201220252856.4
May 30, 2012 (CN) 201220252859.8
Jun. 29, 2012 (CN) 201220314778.6

(51) Int. Cl. H02K 1/27

(52) U.S. Cl. CPC H02K 1/27
USPC 310/68 R; 310/156.01; 310/114

(57) ABSTRACT

A rotor assembly, including: a permanent magnet and a rotor core. The rotor core includes an annular ring and a plurality of magnetic induction blocks. The magnetic induction blocks protrude outward from the outer side of the annular ring. A radial recess is formed between every two adjacent magnetic induction blocks for mounting the permanent magnet. An end plate and a base plate are disposed on an end surface and a bottom surface of the rotor core by injection molding, respectively. A first connecting column passes through a through hole of the magnetic induction block and connects the end plate and the base plate. An end surface of the end plate protrudes upward to form the magnetic loop bracket. A magnetic loop is disposed on a magnetic loop bracket.

### CROSS-REFERENCE TO RELATED APPLICATIONS

This application is a continuation-in-part of International Patent Application No. PCT/CN2012/082635 with an international filing date of Oct. 9, 2012, is also a continuation-in-part of International Patent Application No. PCT/CN2012/082626 with an international filing date of Oct. 9, 2012, and is also a continuation-in-part of International Patent Application No. PCT/CN2012/082648 with an international filing date of Oct. 9, 2012, all designating the United States, all now pending, and further claims foreign priority benefits to Chinese Patent Application No. 201220252859.8 filed May 30, 2012, to Chinese Patent Application No. 201220252856.4 filed May 30, 2012, and to Chinese Patent Application No. 201220314778.6 filed Jun. 29, 2012. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a rotor assembly as well as a brushless direct current motor (BLDC motor) comprising the same.

2. Description of the Related Art

A conventional rotor assembly of a BLDC motor generally includes a rotor core, a permanent magnet, a magnetic loop bracket, and a magnetic loop. The permanent magnet is mounted on the rotor core, and the magnetic loop is disposed on the magnetic loop bracket. However, a typical magnetic loop bracket is made of aluminum material; the magnetic loop bracket is fixed by rivets. Thus, the assembled rotor has a poor accuracy of the relative position; the production process is complicated; and the assembly is not convenient.

A typical brushless DC motor employs two structures. The first structure is realized by mounting the magnetic loop on the magnetic loop bracket on the end part of the rotor and fixing the Hall circuit board on the insulation end of the stator. The second structure is realized by removing the magnetic loop from the rotor, mounting the magnetic loop of the shaft, and fixing the Hall board on the rare end cover. The first structure has a poor stability after being assembled, the Hall circuit board easily falls, the assembly is inconvenient. The second structure has drawback that the assembly and the positioning of the Hall circuit board is inconvenient.

### SUMMARY OF THE INVENTION

In view of the above-described problems, it is one objective of the invention to provide a rotor assembly and a brushless DC motor comprising the same. The rotor assembly of the invention has a simple structure, high accuracy of the relative position, simplified production process, low production cost, and high assembly efficiency. The brushless DC motor of the invention has a simple structure, easy installation, good stability, and high-accuracy positioning.

To achieve the above objective, in accordance with one embodiment of the invention, there is provided a rotor assembly, the rotor assembly comprising: a permanent magnet; a rotor core, the rotor core comprising: an annular ring comprising a central axial bore, a plurality of magnetic induction blocks, a radial recess, an end surface, and a bottom surface; a magnetic loop; a magnetic loop bracket; an end plate comprising an end surface; a base plate; and a first connecting column. Each magnetic induction block comprises a through hole. The magnetic induction blocks protrude outward from an outer side of the annular ring. The radial recess is formed between every two adjacent magnetic induction blocks for mounting the permanent magnet. The end plate and the base plate are disposed on the end surface and the bottom surface of the rotor core by injection molding, respectively. The first connecting column passes through the through hole and connects the end plate and the base plate to form a whole body. The end surface of the end plate protrudes upward to form the magnetic loop bracket. The magnetic loop is disposed on the magnetic loop bracket.

In a class of this embodiment, the radial recess comprises an opening; the magnetic induction blocks disposed on two sides of the opening protrude with a hook block. An outer plate is disposed inside the opening at an inner side of the hook block by injection molding; and the outer plate is connected to the end plate and the bottom plate to form a whole body. A lug boss is disposed on a middle part of a bottom of the radial recess; inner plates are disposed on two sides of the lug boss by injection molding; and the inner plates are connected to the end plate and the bottom plate to form a whole body. The end plate, the bottom plate, the first connecting column, the outer plate, the inner plate, and the magnetic loop bracket are connected to form a whole body by injection molding.

In a class of this embodiment, an outer surface of the magnetic induction block is an exposed curved surface. The outer surface employs a point with a distance deviating from a center of the central axial bore as a center of circle.

In a class of this embodiment, the magnetic loop bracket is in the shape of a ring. A step is arranged on an end part of the magnetic loop bracket. The magnetic loop is disposed on the step. A positioning recess is disposed outside the step on an outer side wall of the magnetic loop bracket. An inner side wall of the magnetic loop protrudes inside with a positioning convex block. The positioning convex block matches with the positioning recess for radially fixing the magnetic loop on the magnetic loop bracket. An inversed clasp is disposed on an end surface of the magnetic loop bracket. A recess is disposed on the inner side wall of the magnetic loop. The inversed clasp matches the recess for axially fixing the magnetic loop on the magnetic loop bracket.

In a class of this embodiment, cement recesses are disposed on the end plate and the bottom plate, respectively; and a plurality of stiffeners are disposed on the outer side wall of the magnetic loop bracket.

In a class of this embodiment, the rotor core comprises a first rotor core and a second rotor core. The first rotor core is stacked on the second rotor core. The first rotor core comprises: a first annular ring comprising a first central axial bore, a first magnetic induction block, and a first recess comprising a first opening. A plurality of first magnetic induction blocks protrude outward from an outer side of the first annular ring. The first recess is formed between every two adjacent first magnetic induction blocks. The second rotor core comprises: a second annular ring comprising a second central axial bore, a second magnetic induction blocks, and a second recess comprising a second opening. A plurality of second magnetic induction blocks protrude outward from an outer side of the second annular ring. The second recess is formed between every two adjacent second magnetic induction blocks. The first magnetic induction block disposed at a right side of the first opening of the upper first recess protrudes with a right hook block. The second magnetic induction block disposed at a left side of the second opening of the lower second recess protrudes with a left hook block. The first recess and the second recess align with each other. The permanent magnet is mounted inside the first recess and the second recess and limited by the left hook block and the right hook block.

In a class of this embodiment, a size of the first recess is the same as a size of the second recess. The first rotor core is the same as the second rotor core. A bottom surface of the first rotor core contacts with an end surface of the second rotor core.

In a class of this embodiment, the right hook block of the first rotor core and the left hook block of the second rotor core are asymmetrically distributed relative to a middle plane MN. The first opening and the second opening are asymmetrically distributed relative to a middle line of the permanent magnet.

In accordance with one embodiment of the invention, there is provided a brushless DC motor comprising the above rotor assembly. The brushless DC motor comprises: a housing; a stator assembly; a rotor assembly, the rotor assembly comprising the permanent magnet, the rotor core, the magnetic loop, the magnetic loop bracket, the end plate comprising the end surface, the base plate, and a first connecting column; a front end cover, the front end cover comprising an end surface; a rear end cover, the rear end cover comprising an end surface; a circuit board; a Hall element; and a Hall fixing frame. The rotor core comprises: the annular ring comprising the central axial bore, the magnetic induction block comprising the through hole, the radial recess, the end surface, and the bottom surface. The rotor assembly is inserted into the stator assembly. The housing and the stator assembly are connected together. The front end cover and the rear end cover are disposed on two ends of the housing, respectively. A plurality of the magnetic induction blocks protrude outward from the outer side of the annular ring. The radial recess is formed between every two adjacent magnetic induction blocks for mounting the permanent magnet. The end plate and the base plate are disposed on the end surface and the bottom surface of the rotor core by injection molding, respectively. The first connecting column passes through the through hole and connects the end plate and the base plate to form a whole body. The end surface of the end plate protrudes upward to form the magnetic loop bracket. The magnetic loop is disposed on the magnetic loop bracket. The circuit board is disposed on the end surface of the front end cover or the rear end cover. The Hall fixing frame is disposed on the circuit board, and the Hall element is disposed on the Hall fixing frame and extends inside the housing at a side edge of the magnetic loop.

In a class of this embodiment, the stator assembly comprises: a stator core and an insulation end. The insulation end is disposed on an end part of the stator core. A plurality of positioning columns protrude upward from the insulation end. A plurality of second connecting columns protrude downward from the Hall fixing stator. A rear part of the second connecting column is provided with a neck. The positioning column is locked in the neck.

In a class of this embodiment, the circuit board is fixed on the rear end cover via a screw, and the Hall fixing frame and the second connecting column are connected to form a whole body by injection molding.

Advantages of the invention are summarized as follows:
1). The end plate and the base plate are disposed on the end surface and the bottom surface of the rotor core by injection molding, respectively. The first connecting column passes through the through hole and connects the end plate and the base plate to form a whole body. The end surface of the end plate protrudes upward to form the magnetic loop bracket. The magnetic loop is disposed on the magnetic loop bracket. Thus, the invention has a simple structure, high accuracy of the relative position, simplified production process, low production cost, and high assembly efficiency; and the installation is not necessary.
2). The magnetic induction blocks disposed on two sides of the opening of radial recess protrude with the hook block. The outer plate is disposed inside the opening at the inner side of the hook block by injection molding. The outer plate is connected to the end plate and the bottom plate to form a whole body. The lug boss is disposed on the middle part of the bottom of the radial recess. Inner plates are disposed on two sides of the lug boss by injection molding. The inner plates are connected to the end plate and the bottom plate to form a whole body. Thus, the permanent magnets are wrapped by the end plate, the bottom plate, the outer plate, and the inner plate; and the connection between each other are firm. The end plate, the bottom plate, the first connecting column, the outer plate, the inner plate, and the magnetic loop bracket are connected to form a whole body by injection molding; thereby simplifying the production process, and lowering the labor cost.
3). The step is arranged on the end part of the magnetic loop bracket. The magnetic loop is disposed on the step. The positioning recess is disposed outside the step on the outer side wall of the magnetic loop bracket. The inner side wall of the magnetic loop protrudes inside with the positioning convex block. The positioning convex block matches with the positioning recess for radially fixing the magnetic loop on the magnetic loop bracket. The inversed clasp is disposed on the end surface of the magnetic loop bracket. The recess is disposed on the inner side wall of the magnetic loop. The inversed clasp matches the recess for axially fixing the magnetic loop on the magnetic loop bracket. The structure of the invention is reasonably designed and firmly assembled.
4). Cement recesses are disposed on the end plate and the bottom plate, respectively. Cement is placed in the cement recess for correcting a dynamic balance, which is simple and convenient.
5). The rotor core comprises the first rotor core and the second rotor core. The first magnetic induction block disposed at the right side of the first opening of the upper first recess protrudes with the right hook block. The second magnetic induction block disposed at the left side of the second opening of the lower second recess protrudes with the left hook block. The first recess and the second recess align with each other. The permanent magnet is mounted inside the first recess and the second recess and limited by the left hook block and the right hook block. Such structure is simple. Not only is the electromagnetic noise effectively inhibited, but also the magnetic performance is strengthened and the amount of the stator winding is decreased, thereby lowering the production cost, improving the performance of the motor. The rotor assembly embedding with a structure of skewed rotor pole is realized, therefore, the rotor assembly is advantageous in embedded magnetism gathering, as well as the skewed-rotor.
6). The size of the first recess is the same as a size of the second recess. The first rotor core is the same as the second rotor core. The structure is reasonably designed, and the procedure is simplified, so that the manufacturability of the design is ensured.
7). The magnetic loop of the brushless DC motor is disposed on the magnetic loop bracket of the end part of the rotor core. The circuit board is disposed on the end surface of the front end cover or the rear end cover. The Hall fixing frame is disposed on the circuit board, and the Hall element is disposed on the Hall fixing frame and extends inside the housing at the side edge of the magnetic loop. The structure is simple and easy to assemble, has a firm connection, good stability, and easy and accurate positioning.
8). A plurality of second connecting columns protrude downward from the Hall fixing stator. The rear part of the second connecting column is provided with a neck. The positioning column is locked in the neck. Thus, Thus, accurate relative positions of the Hall element 67 and the stator winding are ensured, the circumferential positioning of the circuit board 66 is realized. Furthermore, the Hall fixing frame and the second connecting column are connected to form a whole body, thereby being suitable for batch production and decreasing the production cost.

### BRIEF DESCRIPTION OF THE DRAWINGS

FIG. 1 is a stereogram of a rotor assembly of the invention;

FIG. 2 is an exploded view of a rotor assembly of the invention;

FIG. 3 is a front view of a rotor assembly of the invention;

FIG. 4 is a cross-sectional view taken from part A-A of FIG. 3;

FIG. 5 is a lateral view of a rotor assembly of the invention;

FIG. 6 is a cross-sectional view taken from part B-B of FIG. 5;

FIG. 7 is an enlarged view of part of a rotor core of a rotor assembly of the invention;

FIG. 8 is a stereogram of a rotor core in accordance with one embodiment of the invention;

FIG. 9 is an exploded view of a rotor core in accordance with one embodiment of the invention;

FIG. 10 is a top view of a rotor core in accordance with one embodiment of the invention;

FIG. 11 is a cross-sectional view taken from line C-C of FIG. 10;

FIG. 12 is a stereogram of a brushless DC motor in accordance with one embodiment of the invention;

FIG. 13 is an exploded view of a brushless DC motor in accordance with one embodiment of the invention;

FIG. 14 is a top view of a brushless DC motor in accordance with one embodiment of the invention;

FIG. 15 is a cross-sectional view taken from line D-D of FIG. 14;

FIG. 16 is a cross-sectional view taken from line E-E of FIG. 14;

FIG. 17 is an enlarged view of part XVII of FIG. 16; and

FIG. 18 is an exploded view of a stator assembly, a Hall fixing frame, and a circuit board of a brushless DC motor.

### DETAILED DESCRIPTION OF THE EMBODIMENTS

For further illustrating the invention, experiments detailing a rotor assembly and a brushless DC motor comprising the same are described below combined with the drawings.

### Example 1

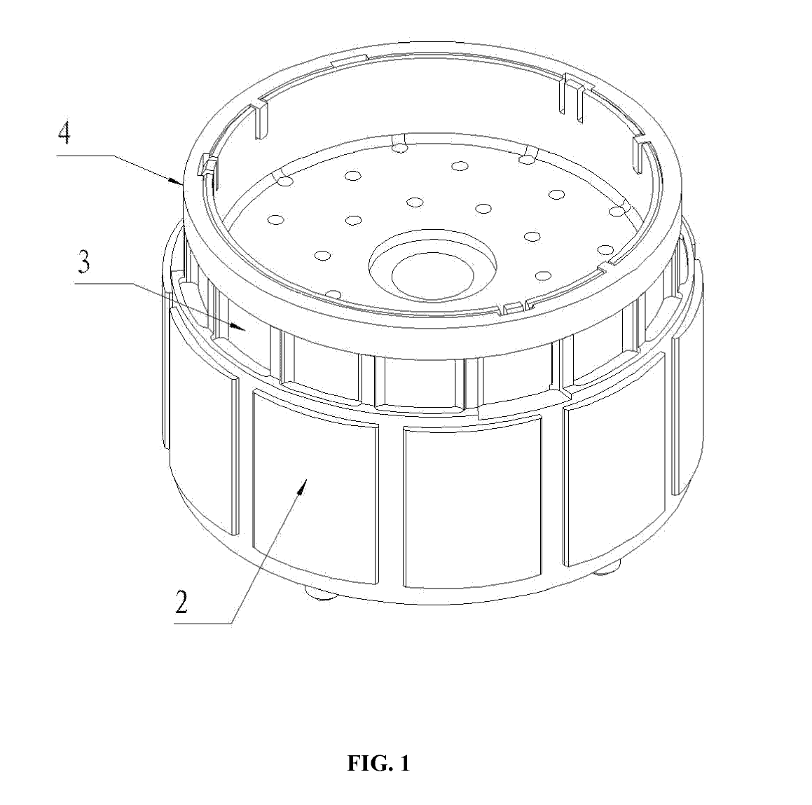

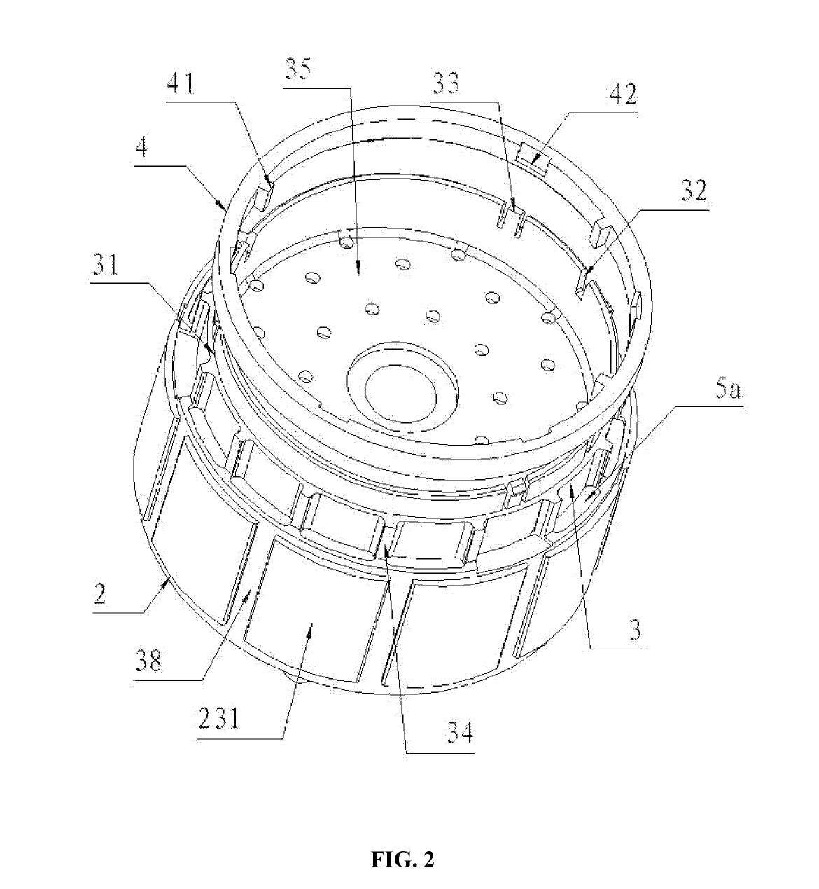

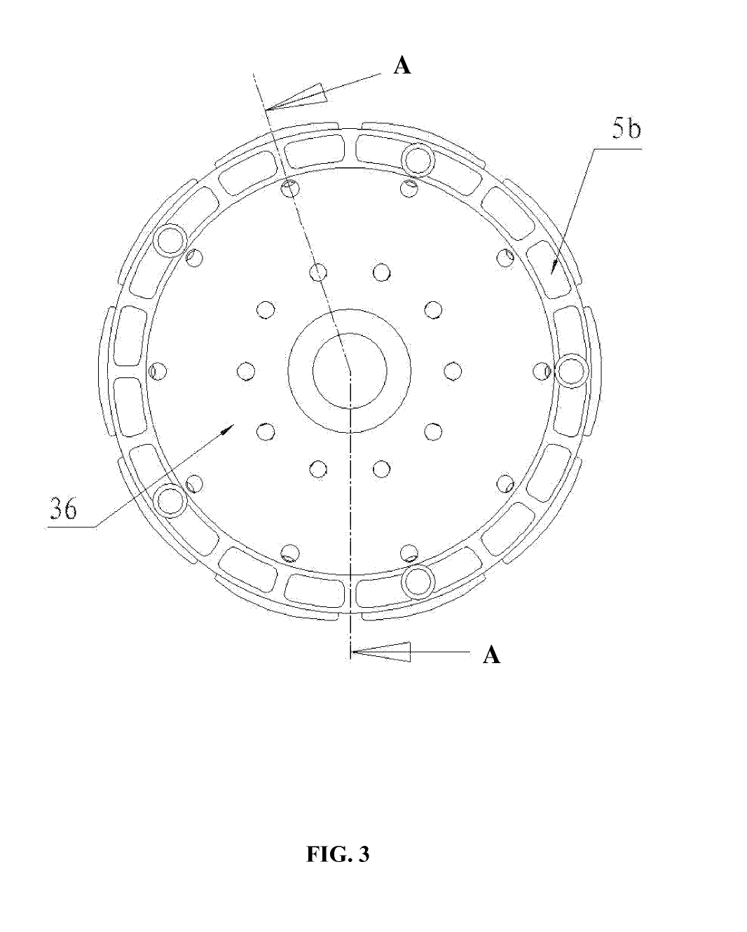

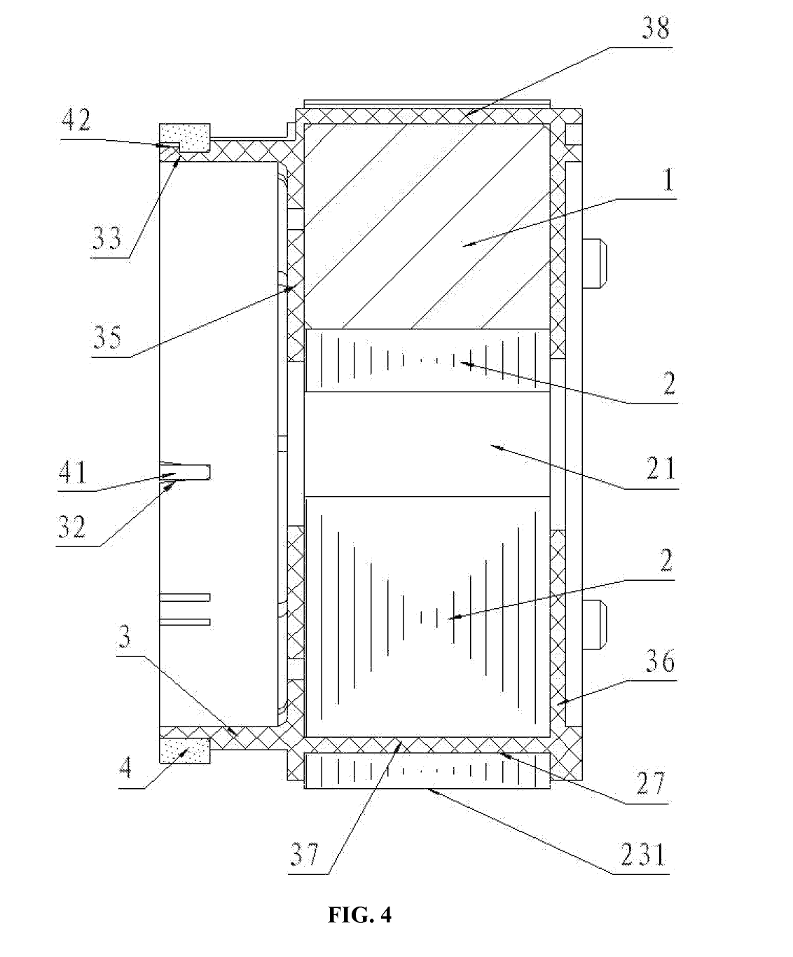

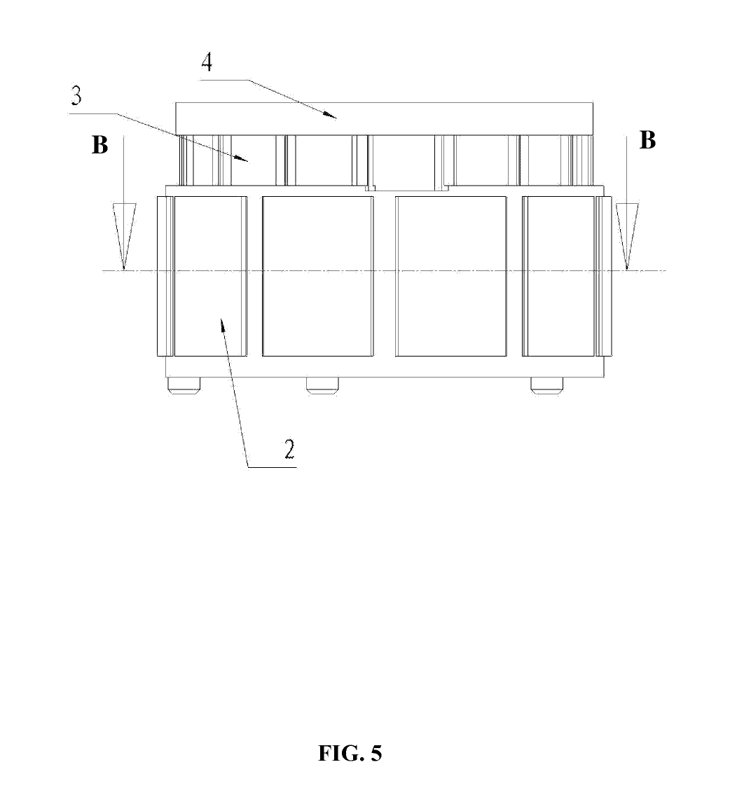

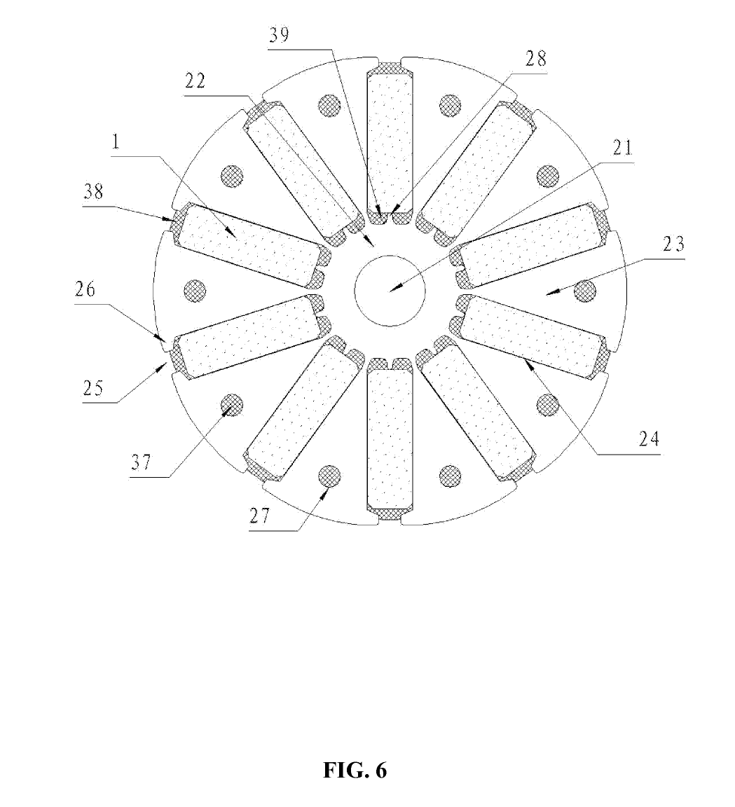

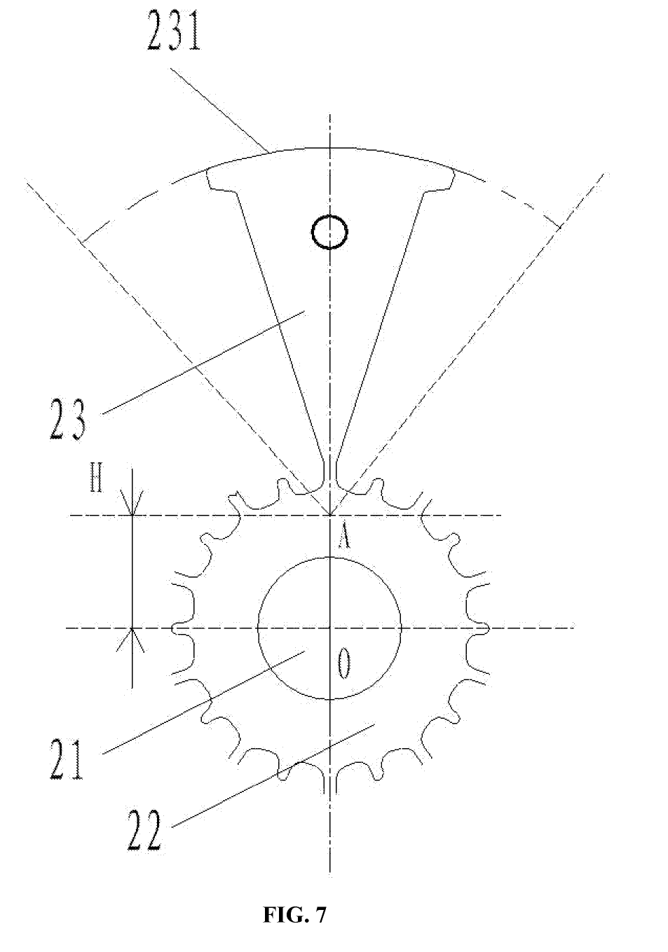

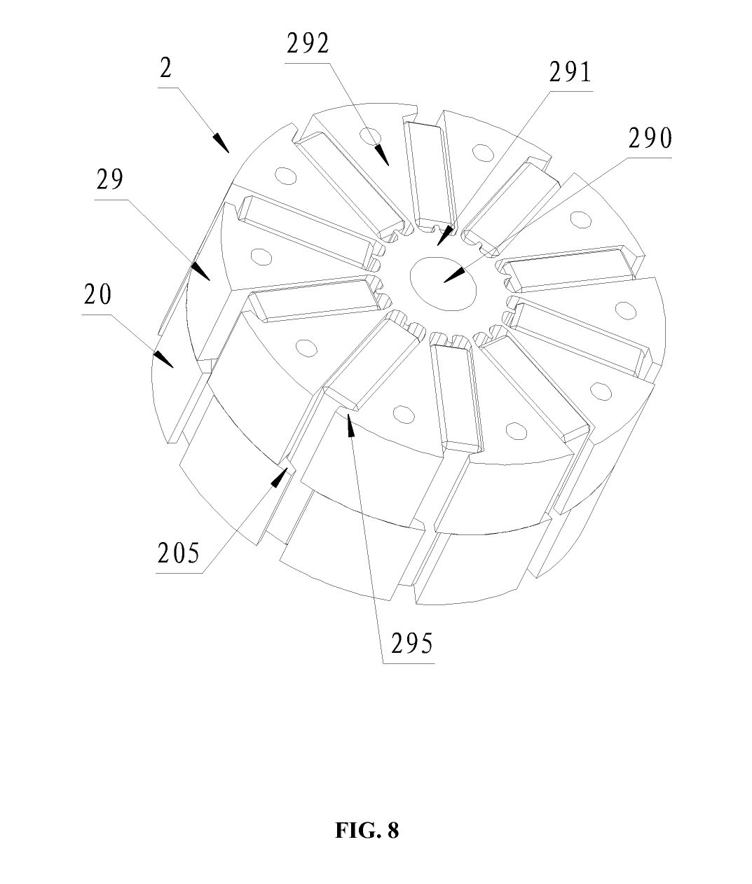

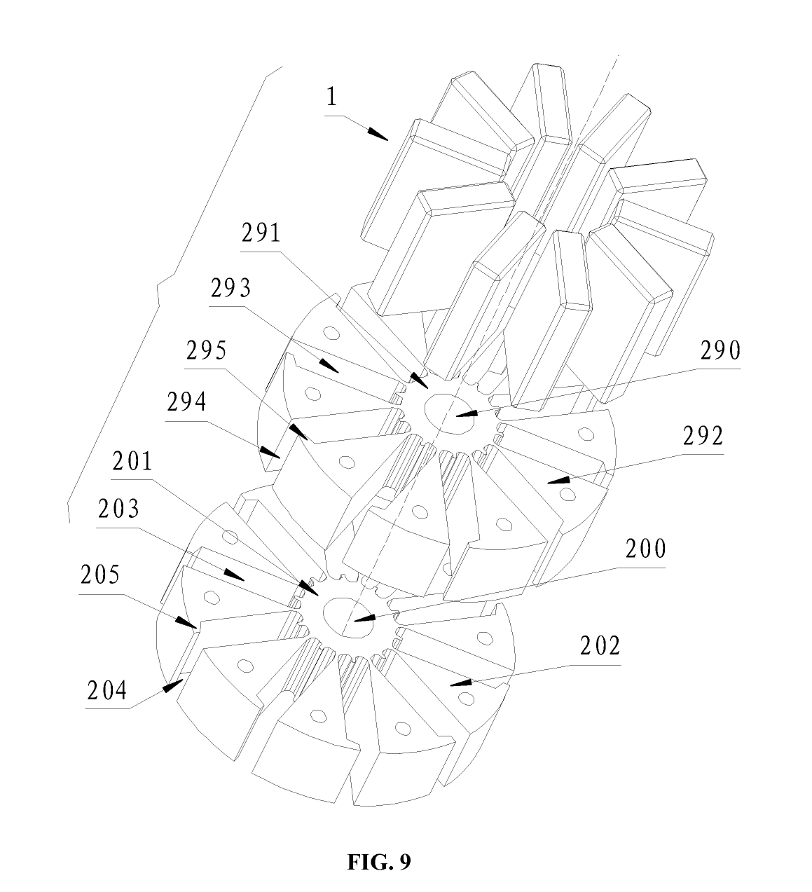

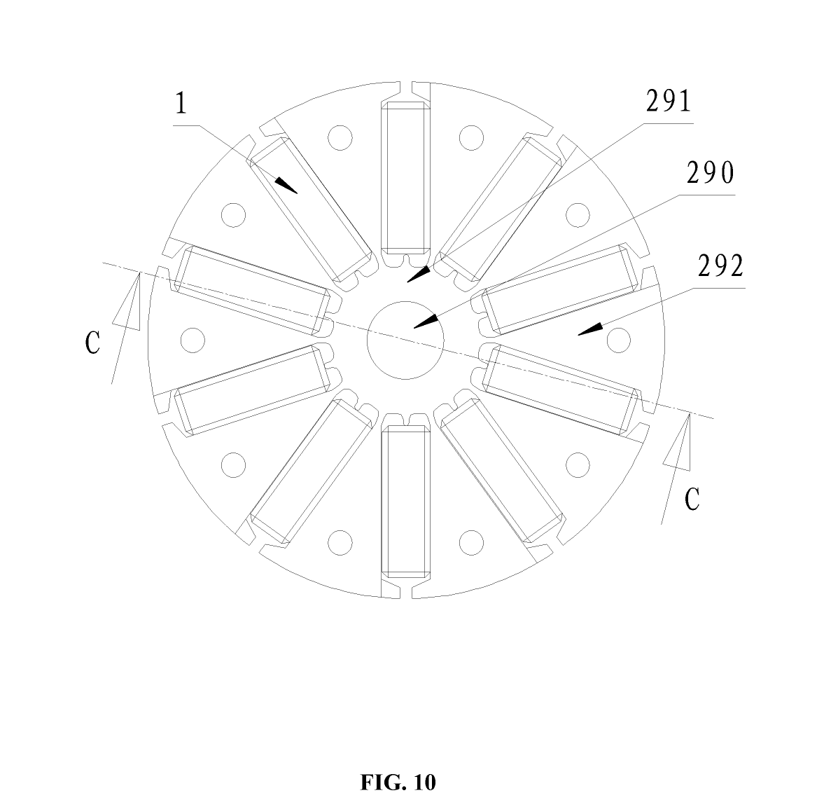

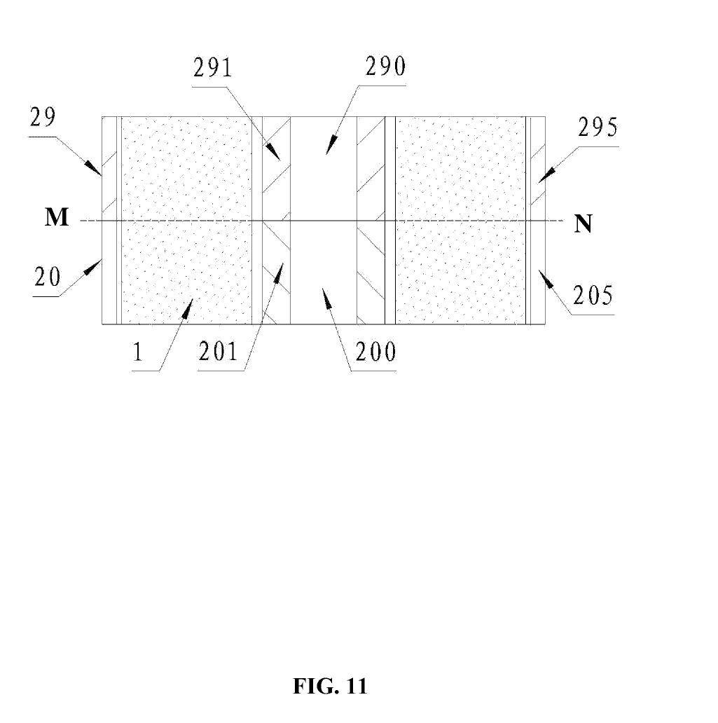

As shown in FIGS. 1-11, a rotor assembly comprises: a permanent magnet 1, a rotor core 2, and a magnetic induction block 23. The rotor core 2 comprises: an annular ring 22 comprising a central axial bore 21, and a plurality of magnetic induction blocks 23. The magnetic induction blocks 23 protrude outward from an outer side of the annular ring 22. Each of the induction blocks 23 is provided with a through hole 27. A radial recess 24 is formed between every two adjacent magnetic induction blocks 23 for mounting the permanent magnet 1. An end plate 35 and a base plate 36 of the rotor core 2 are disposed on the end surface and the bottom surface of the rotor core 2 by injection molding, respectively. A first connecting column 37 passes through the through hole 27 and connects the end plate 35 and the base plate 36 to form a whole body. The end surface of the end plate 35 protrudes upward to form a magnetic loop bracket 3. A magnetic loop 4 is disposed on the magnetic loop bracket 3.

The radial recess 24 comprises an opening 25. The magnetic induction blocks 23 disposed on two sides of the opening 25 protrude with a hook block 26. An outer plate 38 is disposed inside the opening 25 at an inner side of the hook block 26 by injection molding. The outer plate 38 is connected to the end plate 35 and the bottom plate 36 to form a whole body. A lug boss 28 is disposed on a middle part of a bottom of the radial recess 24. Inner plates 39 are disposed on two sides of the lug boss 28 by injection molding. The inner plates 39 are connected to the end plate 35 and the bottom plate 36 to form a whole body. The end plate 35, the bottom plate 36, the first connecting column 37, the outer plate 38, the inner plate 39, and the magnetic loop bracket 3 are connected to form a whole body by injection molding.

An outer surface 231 of the magnetic induction block 23 is an exposed curved surface. The outer surface 231 employs a point A with a distance H deviating from a center of the central axial bore 21 as a center O of circle.

The magnetic loop bracket 3 is in the shape of a ring. A step 31 is arranged on an end part of the magnetic loop bracket 3. The magnetic loop 4 is disposed on the step 31. A positioning recess 32 is disposed outside the step 31 on an outer side wall of the magnetic loop bracket 3. An inner side wall of the magnetic loop 4 protrudes inside with a positioning convex block 41. The positioning convex block 41 matches with the positioning recess 32 for radially fixing the magnetic loop 4 on the magnetic loop bracket 3. An inversed clasp 33 is disposed on an end surface of the magnetic loop bracket 3. A recess 42 is disposed on the inner side wall of the magnetic loop 4. The inversed clasp 33 matches the recess 42 for axially fixing the magnetic loop 4 on the magnetic loop bracket 3.

Cement recesses 5a, 5b are disposed on the end plate 35 and the bottom plate 36, respectively. A plurality of stiffeners 34 are disposed on the outer side wall of the magnetic loop bracket 34.

The rotor core 2 comprises a first rotor core 29 and a second rotor core 20. The first rotor core 29 is stacked on the second rotor core 20. The first rotor core 29 comprises: a first annular ring 291 comprising a first central axial bore 290, a first magnetic induction block 292, and a first recess 293 comprising a first opening 294. A plurality of first magnetic induction blocks 292 protrude outward from an outer side of the first annular ring 291. The first recess 293 is formed between every two adjacent first magnetic induction blocks 292. The second rotor core 20 comprises: a second annular ring 201 comprising a second central axial bore 200, a second magnetic induction block 202, and a second recess 203 comprising a second opening 204. A plurality of second magnetic induction blocks 202 protrude outward from an outer side of the second annular ring 201. The second recess 203 is formed between every two adjacent second magnetic induction blocks 202. The first magnetic induction block 292 disposed at a right side of the first opening 294 of the upper first recess 293 protrudes with a right hook block 295. The second magnetic induction block 202 disposed at a left side of the second opening 204 of the lower second recess 203 protrudes with a left hook block 205. The first recess 293 and the second recess 203 align with each other. The permanent magnet 1 is mounted inside the first recess 293 and the second recess 203 and limited by the left hook block 205 and the right hook block 295.

A size of the first recess 293 is the same as a size of the second recess 203. The first rotor core 29 is the same as the second rotor core 20. A bottom surface of the first rotor core 29 contacts with an end surface of the second rotor core 20.

The right hook block 295 of the first rotor core 29 and the left hook block 205 of the second rotor core 20 are asymmetrically distributed relative to a middle plane MN. The first opening 294 and the second opening 204 are asymmetrically distributed relative to a middle line of the permanent magnet.

Principle of the invention is as follows: the end plate 35 and the base plate 36 are disposed on the end surface and the bottom surface of the rotor core 2 by injection molding, respectively. The first connecting column 37 passes through the through hole 27 and connects the end plate 35 and the base plate 36 to form a whole body. The end surface of the end plate 35 protrudes upward to form the magnetic loop bracket 3. The magnetic loop 4 is disposed on the magnetic loop bracket 3. Thus, the invention has a simple structure, high accuracy of the relative position, simplified production process, low production cost, and high assembly efficiency; and the installation is not necessary.

### Example 2

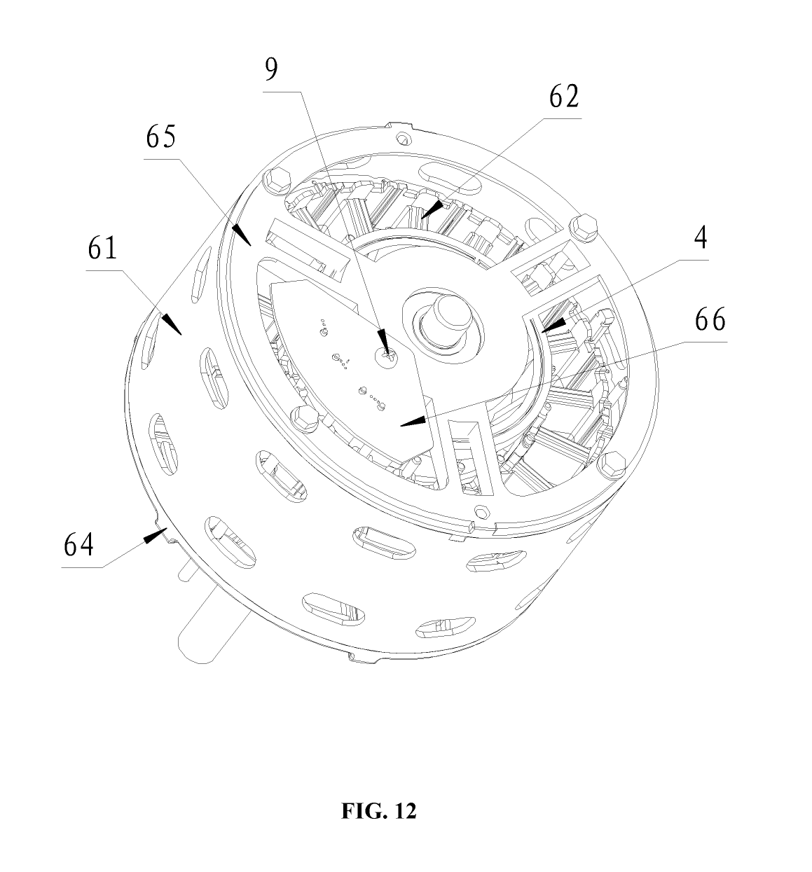

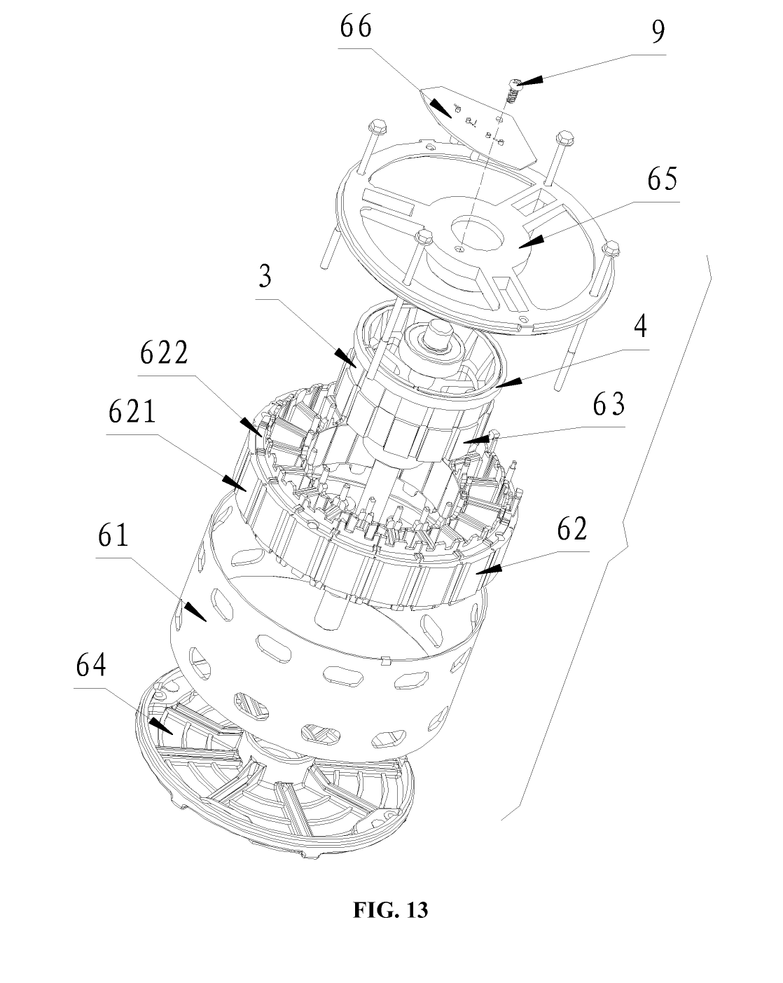

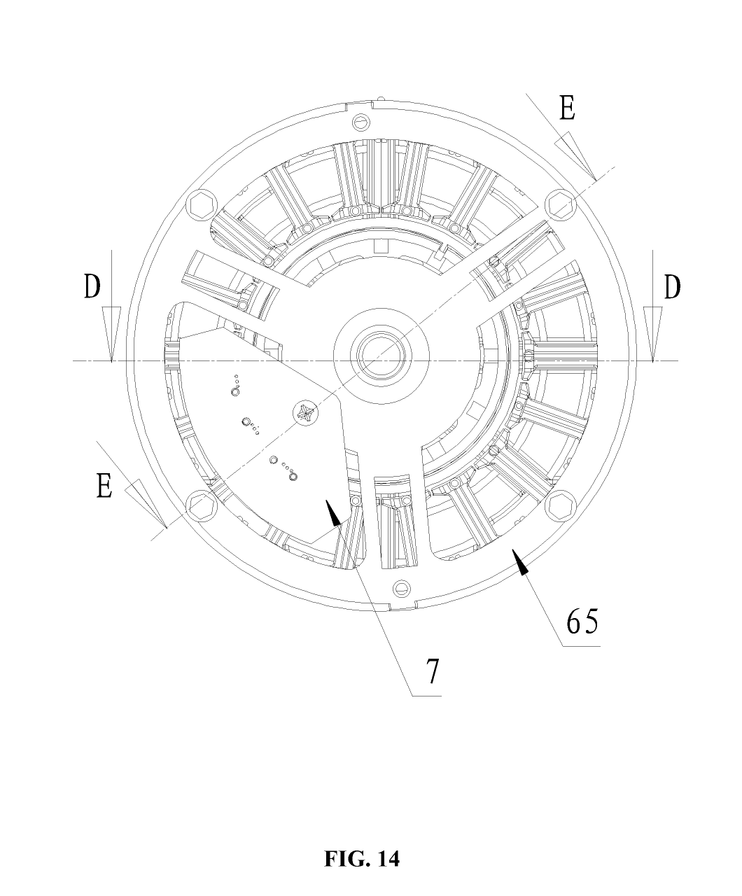

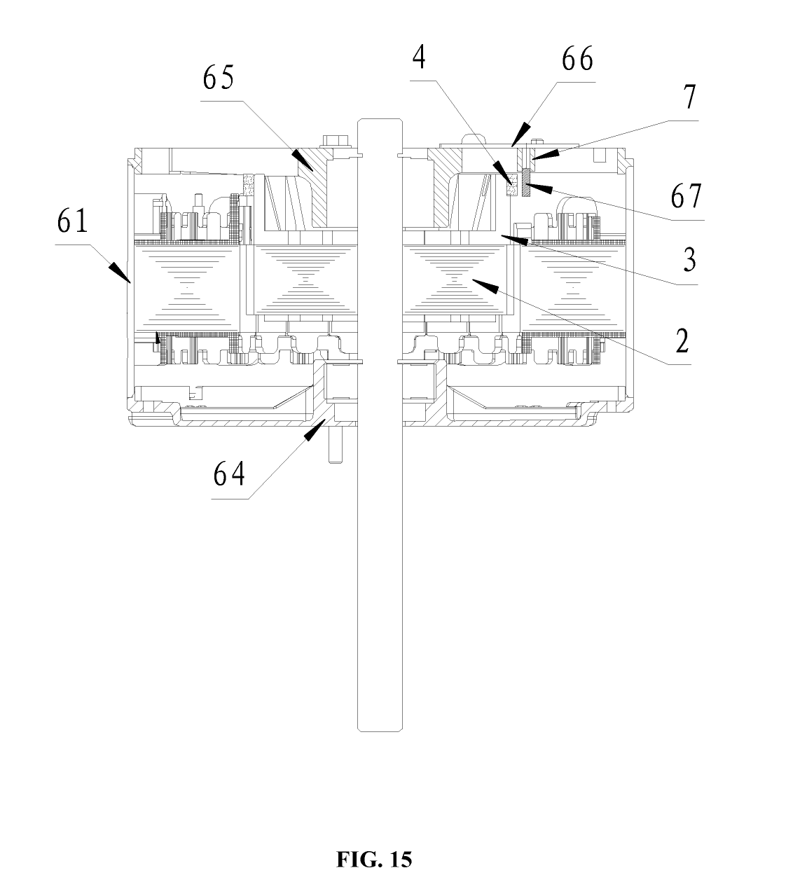

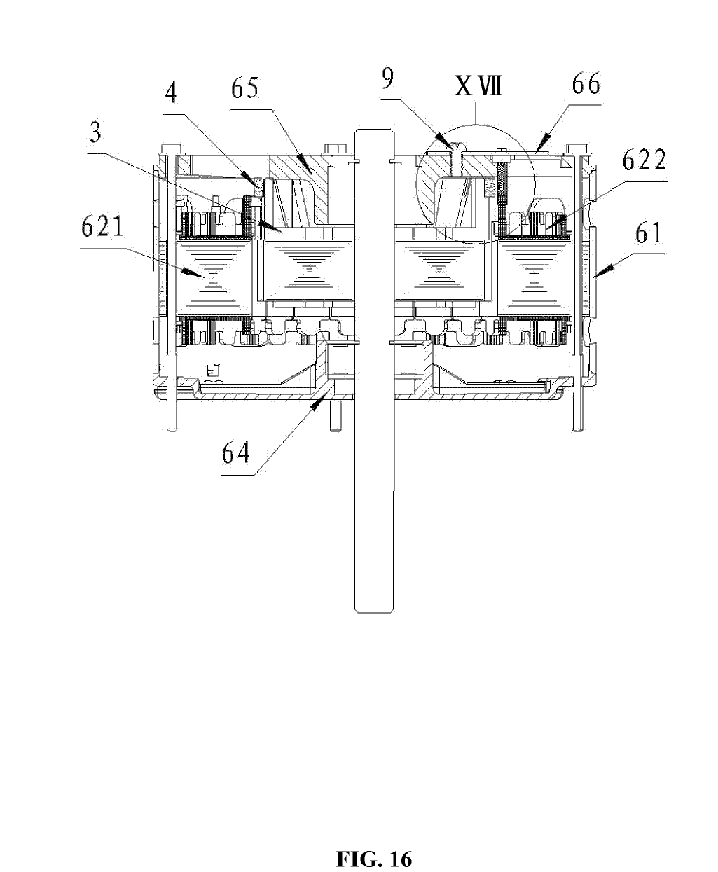

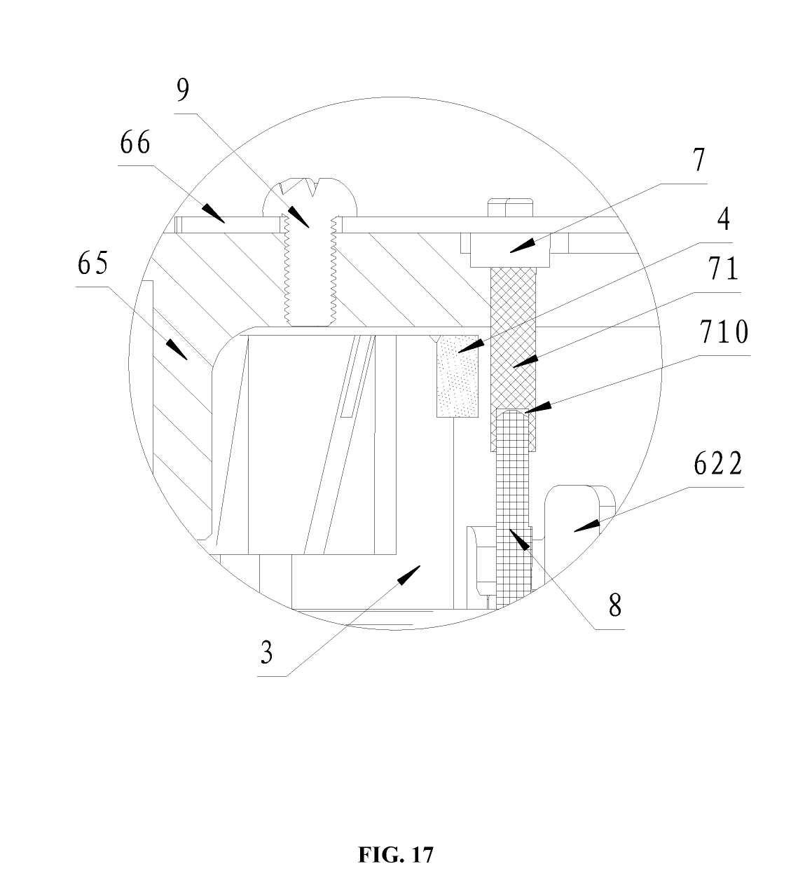

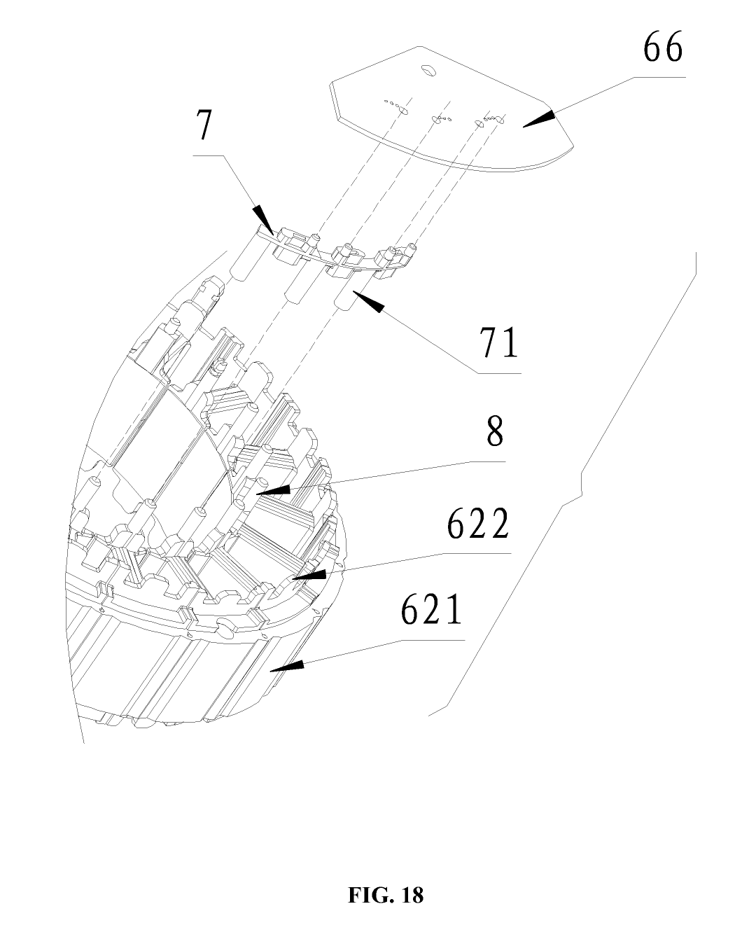

As shown in FIGS. 12-18, a brushless DC motor comprises: a housing 61, a stator assembly 62, a rotor assembly 63, a front end cover 64, a rear end cover 65, a circuit board 66, and a Hall element 67. The rotor assembly 63 is inserted into the stator assembly 62. The housing 61 and the stator assembly 62 are connected together. The front end cover 64 and the rear end cover 65 are disposed on two ends of the housing 61, respectively. The rotor assembly 63 comprises: a permanent magnet 1, a rotor core 2, and a magnetic loop 4. The rotor core 2 comprises: an annular ring 22 comprising a central axial bore 21, and a plurality of magnetic induction blocks 23 protruding outward from an outer side of the annular ring 22. Each of the magnetic induction blocks 23 comprises a through hole 27. A radial recess 24 is formed between every two adjacent magnetic induction blocks 23 for mounting the permanent magnet 1. An end plate 35 and a base plate 36 are disposed on an end surface and a bottom surface of the rotor core 2 by injection molding, respectively. A first connecting column 37 passes through the through hole 27 and connects the end plate 35 and the base plate 36 to form a whole body. An end surface of the end plate 35 protrudes upward to form a magnetic loop bracket 3. The magnetic loop 4 is disposed on the magnetic loop bracket 3. The circuit board 66 is disposed on the end surface of the front end cover 64 or the rear end cover 65. The Hall fixing frame 7 is disposed on the circuit board 66, and the Hall element is disposed on the Hall fixing frame 7 and extends inside the housing 61 at a side edge of the magnetic loop 4.

The stator assembly 62 comprises a stator core 621 and an insulation end 622. The insulation end 622 is disposed on an end part of the stator core 621. A plurality of positioning columns 8 protrude upward from the insulation end 622. A plurality of second connecting columns 71 protrude downward from the Hall fixing stator 7. A rear part of the second connecting column 71 is provided with a neck 710. The positioning column 8 is locked in the neck 710.

The circuit board 66 is fixed on the rear end cover 65 via a screw 9, and the Hall fixing frame 7 and the second connecting columns 71 are connected to form a whole body by injection molding.

Assembly procedure of the circuit board of the invention is as follows: the Hall fixing frame 7 is mounted on the circuit board 66, a plurality of the second connecting column 71 protrude downward from the Hall fixing frame 7. The rear part of each second connecting column 71 is provided with the neck 710. The positioning column 8 protrudes upward from the insulation end 622 and is locked in the neck 710. Thus, accurate relative positions of the Hall element 67 and the stator winding are ensured, and the circumferential positioning of the circuit board 66 is realized. The circuit board 66 is then fixed on the end surface of the rear end cover 65 by the screw 9.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A rotor assembly, comprising:
a) a permanent magnet (1);
b) a rotor core (2), the rotor core (2) comprising: an annular ring (22) comprising a central axial bore (21), a plurality of magnetic induction blocks (23),a radial recess (24), an end surface, and a bottom surface, each magnetic induction block comprising a through hole (27);
c) a magnetic loop (4);
d) a magnetic loop bracket (3);
e) an end plate (35) comprising an end surface;
f) a base plate (36); and
g) a first connecting column (37); wherein
the magnetic induction blocks (23) protrude outward from an outer side of the annular ring (22);
the radial recess (24) is formed between every two adjacent magnetic induction blocks (23) for mounting the permanent magnet (1);
the end plate (35) and the base plate (36) are disposed on the end surface and the bottom surface of the rotor core (2) by injection molding, respectively;
the first connecting column (37) passes through the through hole (27) and connects the end plate (35) and the base plate (36) to form a whole body;
the end surface of the end plate (35) protrudes upward to form the magnetic loop bracket (3); and
the magnetic loop (4) is disposed on the magnetic loop bracket (3).

2. The rotor assembly of claim 1, wherein
the radial recess (24) comprises an opening (25); the magnetic induction blocks (23) disposed on two sides of the opening (25) protrude with a hook block (26); an outer plate (38) is disposed inside the opening (25) at an inner side of the hook block (26) by injection molding; the outer plate (38) is connected to the end plate (35) and the bottom plate (36) to form a whole body;
a lug boss (28) is disposed on a middle part of a bottom of the radial recess (24); inner plates (39) are disposed on two sides of the lug boss (28) by injection molding; the inner plates (39) are connected to the end plate (35) and the bottom plate (36) to form a whole body; and
the end plate (35), the bottom plate (36), the first connecting column (37), the outer plate (38), the inner plate (39), and the magnetic loop bracket (3) are connected to form a whole body by injection molding.

3. The rotor assembly of claim 1, wherein
an outer surface (231) of the magnetic induction block (23) is an exposed curved surface; and
the outer surface (231) employs a point (A) with a distance (H) deviating from a center of the central axial bore (21) as a center (0) of circle.

4. The rotor assembly of claim 2, wherein
an outer surface (231) of the magnetic induction block (23) is an exposed curved surface; and
the outer surface (231) employs a point (A) with a distance (H) deviating from a center of the central axial bore (21) as a center (O) of circle.

5. The rotor assembly of claim 1, wherein
the magnetic loop bracket (3) is in the shape of a ring; a step (31) is arranged on an end part of the magnetic loop bracket (3); and the magnetic loop (4) is disposed on the step (31);
a positioning recess (32) is disposed outside the step (31) on an outer side wall of the magnetic loop bracket (3); an inner side wall of the magnetic loop (4) protrudes inside with a positioning convex block (41); and the positioning convex block (41) matches with the positioning recess (32) for radially fixing the magnetic loop (4) on the magnetic loop bracket (3); and
an inversed clasp (33) is disposed on an end surface of the magnetic loop bracket (3);a recess (42) is disposed on the inner side wall of the magnetic loop (4); and the inversed clasp (33) matches the recess (42) for axially fixing the magnetic loop (4) on the magnetic loop bracket (3).

6. The rotor assembly of claim 2, wherein
the magnetic loop bracket (3) is in the shape of a ring; a step (31) is arranged on an end part of the magnetic loop bracket (3); and the magnetic loop (4) is disposed on the step (31);
a positioning recess (32) is disposed outside the step (31) on an outer side wall of the magnetic loop bracket (3); an inner side wall of the magnetic loop (4) protrudes inside with a positioning convex block (41); and the positioning convex block (41) matches with the positioning recess (32) for radially fixing the magnetic loop (4) on the magnetic loop bracket (3); and
an inversed clasp (33) is disposed on an end surface of the magnetic loop bracket (3); a recess (42) is disposed on the inner side wall of the magnetic loop (4);
and the inversed clasp (33) matches the recess (42) for axially fixing the magnetic loop (4) on the magnetic loop bracket (3).

7. The rotor assembly of claim 1, wherein cement recesses (5a, 5b) are disposed on the end plate (35) and the bottom plate (36), respectively; and a plurality of stiffeners (34) are disposed on the outer side wall of the magnetic loop bracket (34).

8. The rotor assembly of claim 1, wherein
the rotor core (2) comprises a first rotor core (29) and a second rotor core (20); the first rotor core (29) is stacked on the second rotor core (20);
the first rotor core (29) comprises: a first annular ring (291) comprising a first central axial bore (290), a first magnetic induction blocks (292), and a first recess (293) comprising a first opening (294); a plurality of first magnetic induction blocks (292) protrude outward from an outer side of the first annular ring (291); and the first recess (293) is formed between every two adjacent first magnetic induction blocks (292);
the second rotor core (20) comprises: a second annular ring (201) comprising a second central axial bore (200), a second magnetic induction blocks (202), and a second recess (203) comprising a second opening (204); a plurality of second magnetic induction blocks (202) protrude outward from an outer side of the second annular ring (201); and the second recess (203) is formed between every two adjacent second magnetic induction blocks (202);
the first magnetic induction block (292) disposed at a right side of the first opening (294) of the upper first recess (293) protrudes with a right hook block (295);
the second magnetic induction block (202) disposed at a left side of the second opening (204) of the lower second recess (203) protrudes with a left hook block (205); and
the first recess (293) and the second recess (203) align with each other; the permanent magnet (1) is mounted inside the first recess (293) and the second recess (203) and limited by the left hook block (205) and the right hook block (295).

9. The rotor assembly of claim 8, wherein
a size of the first recess (293) is the same as a size of the second recess (203);
the first rotor core (29) is the same as the second rotor core (20); and
a bottom surface of the first rotor core (29) contacts with an end surface of the second rotor core (20).

10. The rotor assembly of claim 8, wherein
the right hook block (295) of the first rotor core (29) and the left hook block (205) of the second rotor core (20) are asymmetrically distributed relative to a middle plane MN; and
the first opening (294) and the second opening (204) are asymmetrically distributed relative to a middle line of the permanent magnet.

11. A brushless DC motor comprising the rotor assembly of claim 1, the motor comprising:
a) a housing (61);
b) a stator assembly (62);
c) the rotor assembly (63), the rotor assembly (63) comprising the permanent magnet (1), the rotor core (2), the magnetic loop (4), the magnetic loop bracket (3), the end plate (35) comprising the end surface, the base plate (36), and a first connecting column (37); the rotor core (2) comprising: the annular ring (22) comprising the central axial bore (21), the magnetic induction block (23) comprising the through hole (27), the radial recess (24), the end surface, and the bottom surface;
d) a front end cover (64), the front end cover (64) comprising an end surface;
e) a rear end cover (65), the rear end cover (65) comprising an end surface;
f) a circuit board (66);
g) a Hall element (67); and
h) a Hall fixing frame (7); wherein
the rotor assembly (63) is inserted into the stator assembly (62); the housing (61) and the stator assembly (62) are connected together; the front end cover (64) and the rear end cover (65) are disposed on two ends of the housing (61), respectively;
a plurality of the magnetic induction blocks (23) protrude outward from the outer side of the annular ring (22); the radial recess (24) is formed between every two adjacent magnetic induction blocks (23) for mounting the permanent magnet (1);
the end plate (35) and the base plate (36) are disposed on the end surface and the bottom surface of the rotor core (2) by injection molding, respectively; the first connecting column (37) passes through the through hole (27) and connects the end plate (35) and the base plate (36) to form a whole body;
the end surface of the end plate (35) protrudes upward to form the magnetic loop bracket (3); the magnetic loop (4) is disposed on the magnetic loop bracket (3); and
the circuit board (66) is disposed on the end surface of the front end cover (64) or the rear end cover (65); the Hall fixing frame (7) is disposed on the circuit board (66), and the Hall element is disposed on the Hall fixing frame (7) and extends inside the housing (61) at aside edge of the magnetic loop (4).

12. The motor of claim 11, wherein
the stator assembly (62) comprises: a stator core (621) and an insulation end (622); the insulation end (622) is disposed on an end part of the stator core (621);
a plurality of positioning columns (8) protrude upward from the insulation end (622);
a plurality of second connecting columns (71) protrude downward from the Hall fixing stator (7);
a rear part of the second connecting column (71) is provided with a neck (710); and
the positioning column (8) is locked in the neck (710).

13. The motor of claim 11, wherein the circuit board (66) is fixed on the rear end cover (65) via a screw (9), and the Hall fixing frame (7) and the second connecting column (71) are connected to form a whole body by injection molding.
